(19) United States
(12) Patent Application Publication
(10) Pub. No.: US 2014/0157606 A1
(43) Pub. Date: Jun. 12, 2014

(54) Lightweight Knife

(71) Applicants: Russell Bruce Owens, Hiawassee, GA (US); Russell David Owens, Washington, DC (US)

(72) Inventors: Russell Bruce Owens, Hiawassee, GA (US); Russell David Owens, Washington, DC (US)

(73) Assignee: Russell David Owens, Washington, DC (US)

(21) Appl. No.: 13/902,815

(22) Filed: May 26, 2013

Related U.S. Application Data
(60) Provisional application No. 61/652,847, filed on May 29, 2012.

(51) Int. Cl. B26B 3/00

(52) U.S. Cl. CPC B26B 3/00
USPC 30/345

(57) ABSTRACT

The present invention relates to a lightweight knife. Conventional knives are made of steel and other heavy materials. While metal knives provide excellent strength and cutting ability, they can be heavy, which adds weight to an individual's load, pack, kit, or supplies on their person. Previous attempts to produce a lightweight knife have focused on replacing steel with lightweight materials. Plastic knives are light and have been produced, but do not provide an effective, sharp cutting edge. The present invention uses plastic insertion molding technology to imbed a partial steel blade in an otherwise plastic knife, significantly reducing overall weight while still providing a strong, effective cutting edge.

### BACKGROUND OF THE INVENTION

Reference is made to a provisional patent application filed on May 29, 2012, under application No. 61/652,847, representing the same information as provided in this document and attached supporting documents.

The present invention relates to knives and, more particularly, to a knife with plastic insertion molding technology, whereby a partial steel blade and claw is imbedded in an otherwise plastic or polymer knife.

Conventional knives are made of steel and other heavy materials. While metal knives provide excellent strength and cutting ability, they can be heavy, which adds weight to an individual's load, pack, kit or supplies on their person.

Previous attempts to create a lightweight knife have focused on replacing steel with lightweight materials such as ceramics. Ceramic knives are light and strong, but can crack or chip when dropped or impacted against hard materials of surfaces. Plastic knives have also been produced, but do not provide an effective, sharp cutting edge.

As can be seen, there is a need for a lightweight knife that provides a strong, sharp cutting edge.

### BRIEF DESCRIPTION OF THE DRAWINGS

FIG. 1 is a side view of a knife according to an exemplary embodiment of the present invention; and

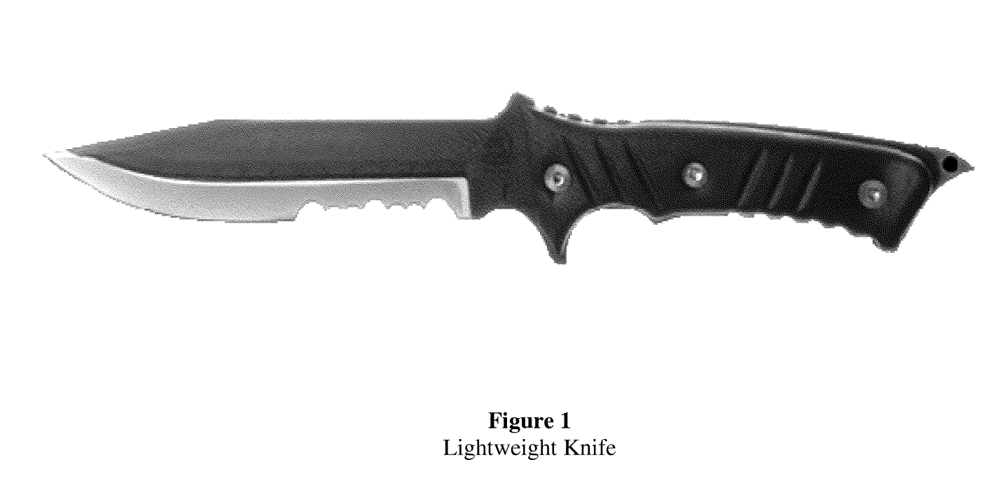

FIG. 2 is an exploded view of a knife according to an exemplary embodiment of the present invention.

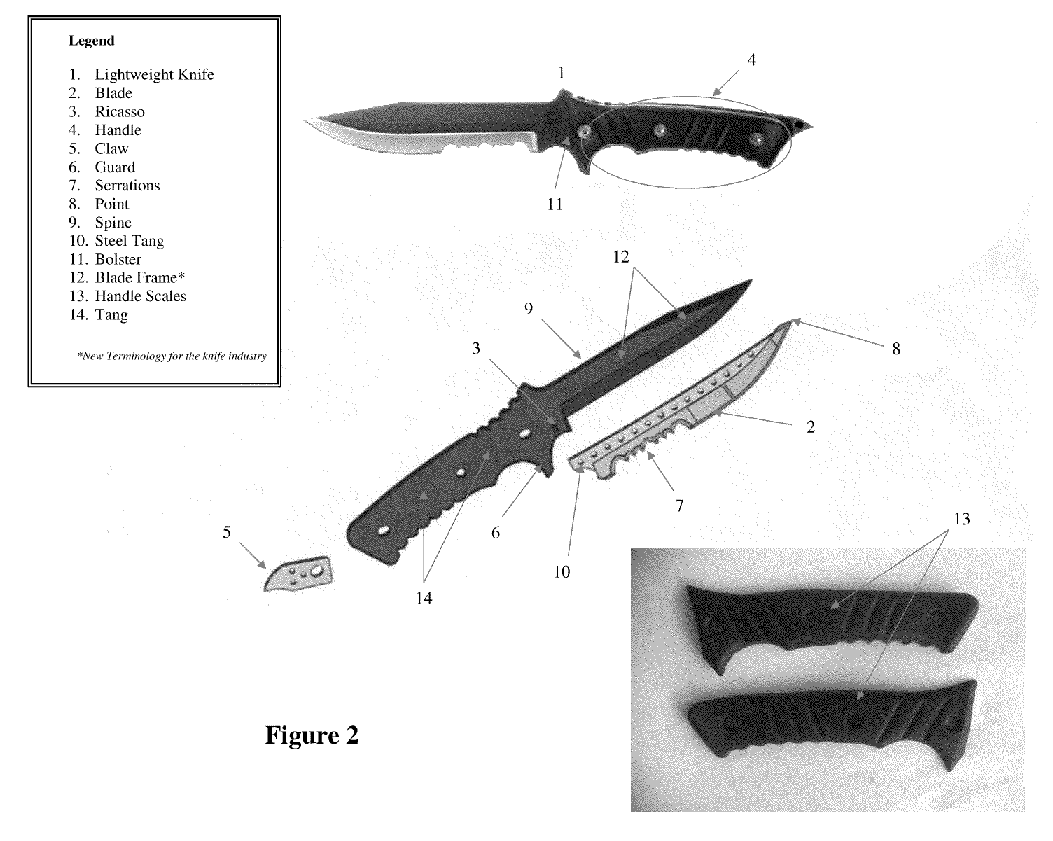

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a knife with plastic injection molding technology that imbeds a partial steel blade. The weight of the knife of the present invention is significantly reduced as compared to conventional knives since materials lighter than metals (i.e., plastic) comprise the tang, structural components of the knife, and even a portion of the blade, while only the necessary components of the knife (i.e., cutting and striking surfaces) are manufactured with a metal, such as steel. The knife of the present invention is lightweight, durable and sharp.

By using a process known as plastic insertion molding technology, a partial steel blade and a claw (glass breaker) can be securely imbedded into a plastic knife. Because the majority of the knife, even the blade frame, is plastic, weight is significantly reduced as compared to conventional, all-metal knives. Because the cutting and striking edges of the knife are steel, the knife performs well. The blade may be formed in various styles, including optional partial or full serrations along the blade. The blade end may terminate in a point or could be altered to point with a pry bar like end, for example.

Referring now to the Figures, a blade 2 can be connected to a blade frame 12 by plastic insertion molding technology. The blade 2 is connected to the blade frame 12 during the manufacturing process when plastic is molded through approximately fourteen holes which have been cut into the blade 2. The number of holes can be greater or less than the example of fourteen, depending on the size of the blade, the size of the holes and the spacing between the holes.

The blade frame 12 can overlap the blade 2 on both sides of the dull portion of the blade 2. The blade frame 12 does not cover the point 8 of the blade 2, does not cover the sharp edges of the blade 2, and does not cover the serration 7, when present.

The steel tang 10 of the blade 2 can be housed in the tang 14 of the blade frame 12. A claw 5 can be housed within the rear of the tang 14 and can protrude from the butt of the handle 4.

Handle scales 13 can be fastened behind the ricasso 3 and to each side of the tang 14 to create the handle 4. The handle scales 13 can be fastened by three pins, rivets, screws, adhesives, or the like.

The steel portions, the blade 2 and the claw 5, in an exemplary embodiment of the present invention, can be cut from sheets of steel, such as 440C steel. In some embodiments, the blade 2 and the claw 5 can be manufactured from a variety of metals, such as carbon steel, Damascus, stainless steel, laminated pattern welding, titanium, and the like.

To make the knife of the present invention, the blade 2 and the claw 5 can be placed in a mold. Heated plastic can be injected into the mold, filling the holes of the blade 2 and the holes of the claw 5 as well as surrounding portions of both the blade 2 and the claw 5. This process creates one piece that includes the blade 2, blade frame 12, spine 9, ricasso 3, guard 6, tang 14, point 8, serrations 7, steel tang 10, and the claw 5.

Additional molds can be used to create rubber handle scales 13. The handle scales 13 can be removed from the mold and attached to both sides of the tang 14 to create the handle 4. The handle scales 13 can be held in place by pins, rivets, screws, or the like, typically about three of these fasteners can be used.

The heat treated steel part of the blade that is placed in the mold before injection molding can be about 6.375 inches long and approximately 0.901 inch in height. However, the steel blade can vary in size, depending on the type of knife being manufactured.

A portion of the tang on the butt end of the handle imbeds a protrusion of steel, also called a claw, as a striking surface. The steel claw is approximately 1.686 inches in length and approximately 0.125 inch thick. The claw includes a hole in it to attach a lanyard. For some knife applications, the claw is omitted or varied in size and shape.

The remaining part of the knife (about 75%) is polymer. The overall length of the knife, in one embodiment, is about 12 inches. The overall weight of the knife is about 5.25 ounces. The blade can have a Rockwell HRC of approximately 54 to 58.

The handle of the knife can be manufactured by several different materials, including rubber, which field tests have shown to be most desirable from a best grip protocol.

The plastic to steel ratio of the knife can be altered to change the weight of the knife. The size and shape of the knife can be altered. The Rockwell HCR of the knife can vary. The methods of the present invention can be applied to various other items, such as daggers, tactical knives, other hunting knives, other fixed blade knives, locking blade knives. The methods of the present invention could be applied in other technologies such as cooking utensils, surgical knives, saws, arrows, axes, and the like.

Various types of plastics, polymers, rubbers or resins can be substituted to provide for the lightweight portions of the knife.

It should be understood, of course, that the foregoing relates to exemplary embodiments of the invention and that modifications may be made without departing from the spirit and scope of the invention as set forth in the following claims.

What is claimed is:

1. A knife having a metal blade imbedded in a plastic frame as herein described.
